(19) United States
(12) Patent Application Publication
(10) Pub. No.: US 2007/0252780 A1
(43) Pub. Date: Nov. 1, 2007

(54) Liquid-Crystal Matrix Display

(75) Inventor: Hugues Lebrun, Coublevie (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: THALES, NEUILLY-SUR-SEINE (FR)

(21) Appl. No.: 11/632,292

(22) PCT Filed: Jul. 12, 2005
(86) PCT No.: PCT/EP05/53320

§ 371 Date: Jan. 12, 2007

(30) Foreign Application Priority Data
Jul. 13, 2004 (FR) 04 07813

(51) Int. Cl. G06T 11/00

(52) U.S. Cl. 345/55

(57) ABSTRACT

A liquid crystal matrix display includes a matrix driver delivering at least a first frame section signal and a second frame selection signal and a first write device and a second write device associated with each pixel element of the matrix, wherein one of the write devices is connected to the associated selection line of the pixel element, and the other is connected to another selection line of the matrix. The write devices have crossed sample and transfer commands, the first frame selection signal causing sampling in the first write device, and contacting of information already sampled in the second write device with the pixel element, the second frame selection signal causing sampling in the second write device, and contacting of information already sampled in the first write device with the pixel element.

The present invention relates to a matrix display comprising a write device that allows a colour sequential mode for addressing the matrix. In such a mode, the data of a red frame, then of a green frame, then of a blue frame are caused to be successively displayed by the matrix, so as to obtain a colour image. Each video display frame thus comprises three colour frames.

Such a display system is used notably for reducing the cost of colour video image projection systems by limiting the number of displays and by limiting the optical equipment to that required by the single display employed. The colour image is formed on the LCD matrix screen that is illuminated successively by three different colours, red, green, blue, for example by means of a disc whose surface is divided into segments of different colours in the illuminating beam.

Other applications are targeted, such as for example applications using virtual reality systems (LCD projection systems for compact systems of the ‘near-to-eye’ type). In this field, a major problem is the size of the system. The use of a single system for displaying virtual images provides a well-adapted solution.

Considering a conventional matrix display used in the usual manner to display a monochrome image, the writing of information into the pixel elements requires only one write device per pixel element. Each pixel element is linked to a selection line corresponding to a row of the matrix and a data line corresponding to a column of the matrix. This write device is typically a sample-and-hold device whose command for storing a data bit presented at the input on the column is generated by the activation of the sampler by the selection line. The image is thus sequentially refreshed by successive activation of the selection lines.

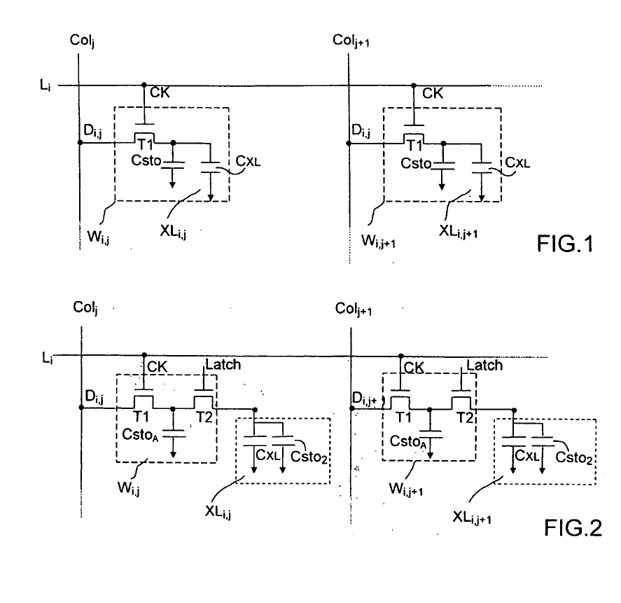

An example of such a write device is shown in FIG. 1. In this figure, two pixel elements XL_{i,j}, and XL_{i, j+1}, of the same matrix row i, are shown. These pixel elements are linked to the selection line Lᵢ, and to a respective data line, Colⱼ for the pixel element XL_{i,j}, and Colⱼ₊₁ for the pixel element XL_{i, j+1}, by a respective write device, W_{i,j} for the pixel element XL_{i,j}, and W_{i, j+1} for the pixel element XL_{i,j+1}.

Each pixel element is represented by its equivalent capacitance, denoted CXL, in parallel with the additional storage capacitor Csto, which is generally included since the value of CXL is generally too small to allow the information to be held for the whole frame time. In one example, the capacitance CXL is around 1.5 femtofarads, and the capacitor Csto has a value of around 50 femtofarads, allowing the various losses from the structure to be compensated.

Each write device, for example W_{i,j} is a sample-and-hold circuit. In the example, this circuit comprises a switching transistor T1 connected between the data line Colⱼ and the pixel element XL_{i,j}. The transistor T1 has its gate connected to the selection line Lᵢ, and one electrode (source or drain) connected to the data line Colⱼ. The storage capacitor Csto is connected between the other electrode of the transistor T1 and a reference voltage, typically ground. When the selection line Lᵢ is activated, the transistor becomes similar to a short-circuit, allowing the storage capacitor Csto to be charged up to the voltage level VD applied to the column and representing the data bit D to be displayed. Subsequently, the selection line is deactivated and the transistor returns to the non-conducting state. The data bit D is stored in the capacitor Csto.

When all the selection lines of the matrix have been successively activated, all the data of the frame are stored in the matrix write devices. Each pixel element now has a voltage level corresponding to the data to be displayed on this element.

Such a system does not work in colour sequential mode. Indeed, for each frame corresponding to an image, it is necessary to sample the data relative to the colour red, then transfer it onto the pixel elements, do the same with the colour green, then the colour blue. The conventional colour sequential addressing method would cause, for example, the red colour data to be erased in favour of the green colour data during the green illumination time. The result would be an unacceptable loss of calorimetric information.

It is therefore indispensable to have, at the level of each pixel, at least two sample-and-hold devices in series, as illustrated in FIG. 2. The first sample-and-hold device(transistor T1) is used according to the mode described previously in order to sample the information on an intermediate storage capacitor CSto_{A} (sampling capacitor). The second sample-and-hold device (transistor T2) is activated for all the pixels at the end of each colour frame in order to transfer the information between the sampling capacitor CSto_{A} and a storage capacitor CSto_{B} where it will remain valid over the whole colour frame.

The pixel model in FIG. 2 has a major defect that makes it difficult to use. The voltage sampled is diluted over the two capacitors CSto_{A} and CSto_{B} during the transfer at the end of the colour frame. This voltage dilution is unacceptable for an LCD screen with an active matrix on silicon, since it imposes the use of addressing voltages that are incompatible with the capabilities of the transistors.

New write devices have thus been developed with associated drivers in order to improve the write performance of the display. In these devices, the two samplers T1, T2 have been doubled on each of the pixels such that, one frame in two, the sampling capacitor also serves as storage capacitor. This results in almost no voltage dilution during the transfer.

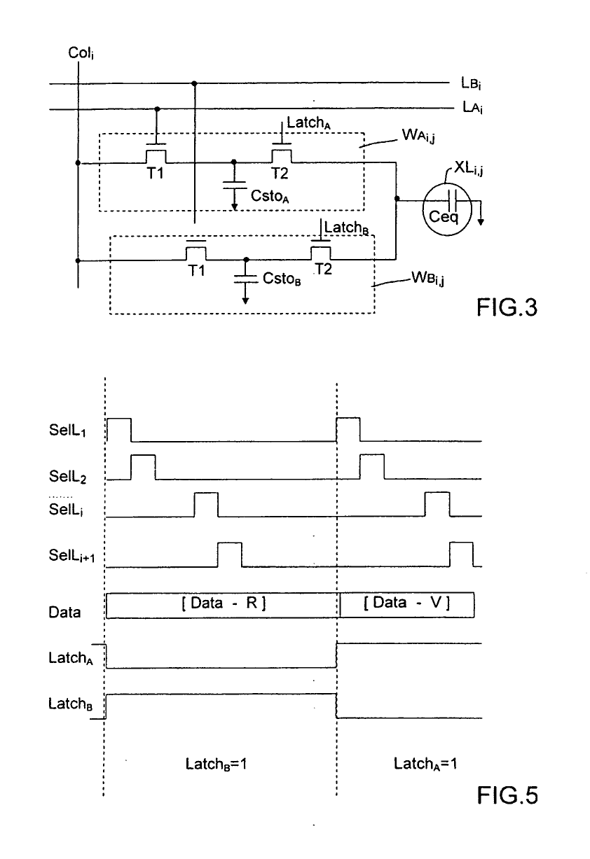

In order to differentiate the control of each of the samplers, the selection line has been doubled up in the structure of the matrix. Accordingly, as shown in FIG. 3, there are two selection lines LAᵢ and LBᵢ for each row i of the matrix. The lines LAᵢ form a first group A of selection lines of the matrix. The lines LBᵢ form a second group B of selection lines of the matrix. The write device is doubled up in the same fashion, one WA_{i,j} to be controlled by the selection line LAᵢ, the other WB_{i,j} to be controlled by the selection line LBᵢ. The addressing driver must control twice as many lines, with commands that alternate depending on the frame.

For example, on one frame, if the frame signal Latch_{A} is at 1 and the frame signal Latch_{B} is at 0, it activates the lines LB_{I} of the group B, one after another, in order to sample the data of a new frame, while the contact is established between the information stored during the previous frame in the write devices WA_{i,j} of the group A and the pixel elements. When the frame signal Latch_{A} becomes 0 and the frame signal Latch_{B} becomes 1, it activates the lines LAᵢ of the group A, one after another, in order to sample the data of a new frame, while the contact is established between the information stored during the previous frame in the write devices WB_{i,j} of the group B and the pixel elements. In summary, the signals Latch_{A} and Latch_{B} are frame indicator signals. Depending on these signals, the driver applies these activation signals, generally supplied by a shift register, towards the group A or the group B of the selection lines. This solution however turns out to be very bulky, since it multiplies the number of matrix lines by two, with all the problems of layout, of intersections with other signals and of space requirements that this implies. It also multiplies the number of line driver circuits by two.

A subject of the invention is a matrix display of reduced size.

Another subject of the invention is a matrix display designed for a colour sequential display mode which does not involve the doubling up of the rows or of the columns of the matrix.

The basic idea of the invention is to use two write devices with crossed controls.

Another basic idea of the invention is to use, for the pixels of a row, the selection line associated with that row and another selection line of the matrix for controlling both write devices with crossed control of each pixel element. Advantageously, this other selection line is the next line. For the last row of the matrix, it will be an additional line. In this way, the number of additional connection lines is significantly reduced. Moreover, few additional switching elements are required in order to form the crossed control. A competitive display system of reduced size is obtained.

Accordingly, the invention relates to a liquid crystal matrix display, comprising:

a matrix of pixel elements, each pixel element being associated with a selection line and a data line of the matrix;

a matrix driver delivering at least a first frame selection signal and a second frame selection signal;

a first write device and a second write device associated with each pixel element of the matrix, the said write devices being of the type with crossed sampling and transfer commands, the first frame selection signal causing the sampling in the first write device and the contacting of information already sampled in the second write device with the pixel element, the second frame selection signal causing the sampling in the second write device and the contacting of information already sampled in the first write device with the pixel element,

a write device being connected to the associated selection line of the pixel element, and the other device being connected to another selection line of the matrix.

The first frame selection signal and the second frame selection signal are mutually inverted binary signals.

According to a mode of operation designed to be used in a system for modifying all the points of an image simultaneously on a matrix display, the driver inverts the levels of the said first frame selection signal and second frame selection signal at each new frame.

According to another mode of operation designed to be used in a projection system comprising a matrix display designed for use in colour sequential mode, the driver inverts the levels of the said first frame selection signal and second frame selection signal at each new colour frame.

Other features and advantages of the invention are presented in the following description of the invention, which is non-limiting and is presented by way of example and with reference to the appended drawings, in which:

FIG. 1, already described above, shows a write device of a conventional matrix display;

FIG. 2, already described above, shows a single sample-and-hold per pixel;

FIG. 3, already described above, shows a write device according to the prior art allowing a colour sequential display control;

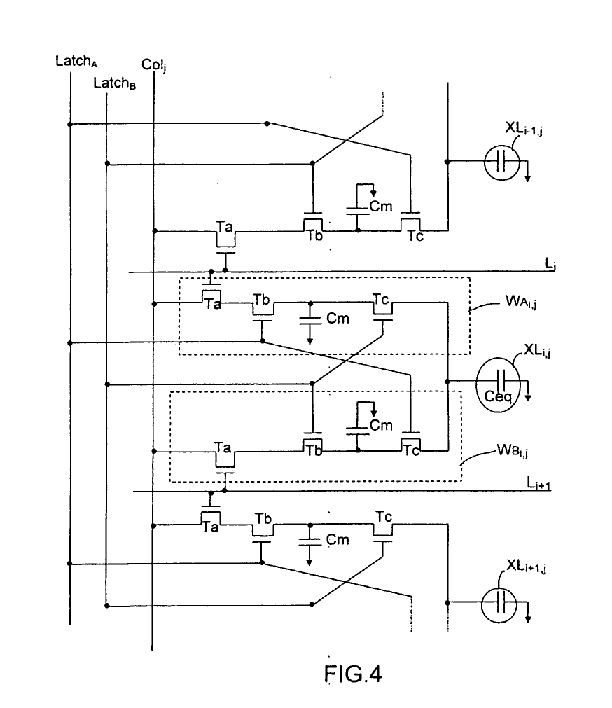

FIG. 4 shows a write device according to the invention allowing a colour sequential display control;

FIG. 5 is a timing diagram of the control signals of a display according to the invention;

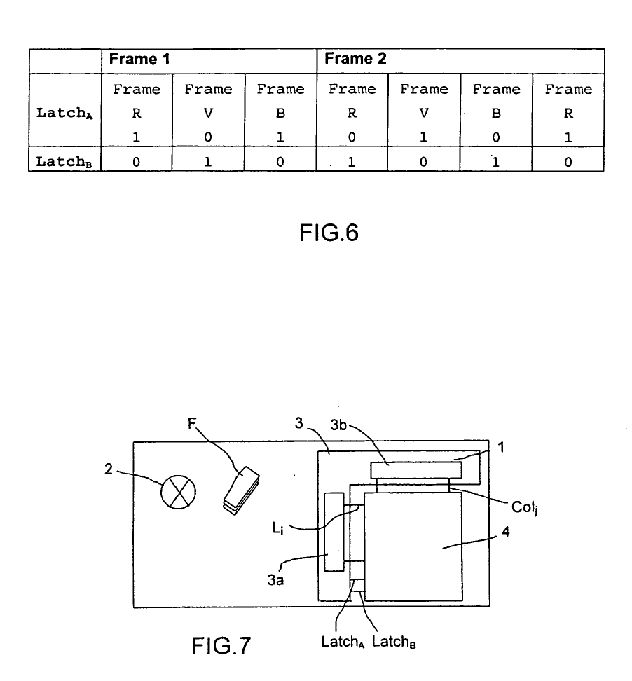

FIG. 6 is a table recapitulating a corresponding control sequence; and

FIG. 7 is a schematic representation of a projection system using a matrix display according to the invention.

Pixel elements XL_{i-1,j}, XL_{i,j}, XL_{i+1,j}, of a matrix display and their associated write devices are shown in FIG. 3.

With each pixel element is associated a first write device and a second write device with crossed sample and transfer commands, controlled by frame selection signals Latch_{A} and Latch_{B}, one of the devices being associated with the selection line of the pixel element in question, the other device being associated with another selection line of the matrix.

More precisely, if the pixel element XL_{i,j} shown in FIG. 4 is considered, a first write device WA_{i,j} is provided, connected between the data line Colⱼ and the pixel element. This device is selected by activating the selection line Lᵢ of the pixel element. It is activated for the sampling of the data bit presented on the data line Colᵢ, by the first frame selection signal Latch_{A}, and it is data-transfer commanded by the second frame selection signal Latch_{B}.

A second write device WB_{i,j} is provided, connected between the data line Colⱼ and the pixel element. This device is selected by activating the next selection line, Lᵢ₊₁. It is sampling activated with regard to the data bit presented on the data line Colⱼ by the second frame selection signal Latch_{B}, and it is data-transfer commanded by the second frame selection signal Latch_{A}.

In each device, the sampling command and the transfer command are mutually exclusive. When a sampling command is sent to a device, the other device receives a transfer command and vice versa. More particularly, in one exemplary embodiment and as illustrated in FIG. 4, each write device comprises a first switching transistor Ta, whose gate is connected to the associated selection line and one electrode of which is connected to the associated data line. This first transistor is connected in series with a second transistor Tb, whose gate is controlled by one of the two frame selection signals. This second transistor has one electrode connected to an electrode of the first transistor and the other electrode connected to a storage capacitor Cm connected to a voltage reference, typically ground. The sampled data is stored on this capacitor. A third transistor Tc is connected between the capacitor and the pixel element. It is controlled on its gate by the other frame selection signal. It allows the charge to be transferred between the storage capacitor Cm and the equivalent capacitance Ceq of the pixel element.

More generally, in each write device there is a first switching circuit Ta, a second switching circuit Tb and a third switching circuit Tc connected in series between the data line Colⱼ and the pixel element XL_{i,j}, and a storage capacitor Cm, of which one terminal is connected between the said second and third switching circuits Tb and Tc and another terminal to a voltage reference element. In the example, the switching circuits are MOS transistors. However, any other appropriate semiconductor switching device may be used, depending in particular on the technology used.

Compared with the structure of the prior art described in relation to FIGS. 1, 2 and 3, the structure of the invention only requires one additional connection line, in order to connect the second write device of the last row of the matrix to the selection line of the first row of the matrix. It costs two extra transistors per device, but in terms of surface area occupied, this is negligible with respect to the doubling up of the lines in the structure of FIG. 3.

Furthermore, another benefit is a reduction of the leakages in the capacitance Ceq by the two transistors Ta and Tb.

The mode of sequencing of a matrix display according to the invention is detailed in FIG. 5.

The frame selection signals are mutually opposing binary signals, of binary state 0 or 1.

In a first sequence, if Latch_{A}=0 and Latch_{B}=1, the data applied to the columns by an associated driver are sampled and stored successively in each row i of pixel elements, in the write devices W_{i,j} activated by the next selection line Lᵢ₊₁ of this row, while the data stored during the previous frame in the write devices WA_{i,j}, controlled by the selection line Lᵢ of this row i, are transferred into the pixel elements XL_{i,j} of the row.

In a following sequence, Latch_{A}=1 and Latch_{B}=0, the data applied to the columns by the associated driver are sampled and stored successively in each row i of pixel elements, in the write devices WA_{i,j} controlled by the selection line Lᵢ of this row, while the data stored during the previous frame in the write devices WB_{i,j} activated by the next selection line Lᵢ₊₁ of this row i, are transferred into the pixel elements XL_{i,j} of the row.

When the sampling command is effected by the frame selection signal Latch_{B}, the row selection signal emitted by the driver which will activate the transistor Ta of the device WB_{i,j} (by a shift register) and allow the sampling is the selection signal that is emitted onto the following row i+1. From FIG. 5, in the first sequence, the signal SelL₁ triggers the sampling on the last n-th row of the matrix, the signal SelL₂ triggers the sampling on the first row of the matrix, the signal SelLᵢ₊₁ triggers the sampling on the i-th row of the matrix and so on.

When the sampling command is effected by the frame selection signal Latch_{A}, it is the row selection signal emitted by the driver which will activate the transistor Ta of the device WA_{i,j} (by a shift register) and allow the sampling. Again with regard to FIG. 5, in the second sequence, the signal SelL₁ triggers the sampling on the first row 1 of the matrix, the signal SelL₂ triggers the sampling on the second row of the matrix, the signal SelLᵢ triggers the sampling on the i-th row of the matrix and so on.

In practice, this can be managed either at the row driver level, by staggering the signals appropriately, or at the column driver level, by appropriately staggering the sets of data to be displayed, such that the data of the correct row is always sampled.

It will be noted that, although in the example illustrated in FIG. 4 the line Lᵢ and the next line Lᵢ₊₁ have been used to control the write devices of the pixel elements of the i-th row, the line Lᵢ and the line Lᵢ₋₁, or any other line different from Lᵢ, could just as well be taken. One advantage of taking an immediately adjacent line, Lᵢ₊₁ or Lᵢ₋₁, resides in the simplicity of connection and of management.

More generally, the invention applies to a system for modifying all the points of an image simultaneously on a matrix display comprising a driver according to the invention. At each new frame, the frame selection signals Latch_{A} and Latch_{B} are inverted in order for the information stored in the preceding frame to be displayed, and to sample the information corresponding to the new frame.

In order to display a colour image by means of a matrix display according to the invention, for each frame corresponding to an image, a colour sequential driver will apply a colour frame for each colour, typically a red frame, a green frame and a blue frame. At each new colour frame, the frame selection signals Latch_{A} and Latch_{B} are inverted, in order for the information that was stored during the preceding colour frame to be displayed, corresponding to the colour with which it is illuminated, and to sample the information corresponding to the new colour frame, within the same period.

Although more particularly adapted to the use of matrix displays of the LCOS type that are more particularly targeted in the applications concerned, such as video projection systems and virtual reality systems, the invention can be applied to any type of display that it would be desirable to want to control according to the principles presented in the invention.

A projection system 1 using such a matrix display 4 will typically comprise, as shown schematically in FIG. 7, a white light source 2, typically of 500 watts.

The system comprises a driver 3 for the display 4, delivering the frame selection signals Latch_{A} and Latch_{B} according to the invention and formed from a driver 3a for the selection lines and from a driver 3b for the data lines.

In the case of a colour video image projection system, the system additionally comprises colour filters F. The display is sequentially illuminated with red, green then blue light, by means of the filters. It is controlled in an appropriate manner by the driver using the frame selection signals Latch_{A} and Latch_{B}, in order to display the information stored at the preceding colour frame, corresponding to the colour with which it is illuminated, and to sample the information corresponding to the new colour frame.

The invention can be applied to other systems. It can notably be applied to a video system comprising such a projection system, for virtual reality applications.

1-11. (canceled)

12. A liquid crystal matrix display, comprising:
a matrix of pixel elements, each pixel element being associated with a selection line and a data line of the matrix;
a matrix driver delivering at least a first frame selection signal and a second frame selection signal;
a first write device and a second write device associated with each pixel element of the matrix, the write devices including crossed sampling and transfer commands, the first frame selection signal causing sampling in the first write device and contacting of information already sampled in the second write device with the pixel element, the second frame selection signal causing sampling in the second write device and the contacting of information already sampled in the first write device with the pixel element; and
one of the write devices being connected to the associated selection line of the pixel element, and the other of the write devices being connected to another selection line of the matrix.

13. A matrix display according to claim 12, wherein the first frame selection signal and the second frame selection signal are mutually inverted binary signals.

14. A matrix display according to claim 13, wherein the driver inverts the levels of the first frame selection signal and second frame selection signal at each new frame.

15. A matrix display according to claim 13, wherein the driver inverts the levels of the first frame selection signal and second frame selection signal at each new color frame.

16. A matrix display according to claim 12, wherein each of the first and second write devices comprises a first, a second, and a third switching circuit connected in series between the data line and the pixel element, and a storage capacitance of which one terminal is connected between the second and third switching circuits and another terminal to a reference voltage element.

17. A matrix display according to claim 12, in which the switching circuits are transistors.

18. A system for modifying all points of an image simultaneously on a matrix display according to claim 14, the frame selection signals being inverted at each new frame, to cause information stored at a preceding frame to be displayed, and to sample information corresponding to a new frame.

19. A projection system comprising a matrix display according to claim 15, configured to be used in a color sequential mode, wherein the frame selection signals are inverted at each new color frame.

20. A projection system according to claim 19, comprising a white light source and color filters, the display being sequentially illuminated with red light, with green light, and with blue light, according to a predetermined sequence by the color filters, and the driver configured to display the information stored at the preceding color frame, corresponding to the color with which the display is illuminated.

21. A video image display system comprising a projection system according to any one of claims 7 to 9.

22. A virtual reality system comprising a projection system according to any one of claims 7 to 9.
